(19) United States
(12) Patent Application Publication
(10) Pub. No.: US 2013/0063251 A1
(43) Pub. Date: Mar. 14, 2013

(54) MONITORING RESOURCES USING RADIO FREQUENCY IDENTIFICATION TECHNOLOGIES

(71) Applicant: Michael Allen, Glasgow, KY (US)

(72) Inventor: Michael Allen, Glasgow, KY (US)

(73) Assignee: UNITED PARCEL SERVICE OF AMERICA, INC., ATLANTA, GA (US)

(21) Appl. No.: 13/613,876

(22) Filed: Sep. 13, 2012

Related U.S. Application Data
(60) Provisional application No. 61/534,083, filed on Sep. 13, 2011.
(60) Provisional application No. 61/597,253, filed on Feb. 10, 2012.

(51) Int. Cl. G06K 7/01

(52) U.S. Cl. 340/10.1

(57) ABSTRACT

Computer program products, methods, systems, apparatus, and computing entities are provided for monitoring resources. In one embodiment, RFID tags/sensors can be attached to resources and mobile assets may include the ability to communicate with such RFID tags/sensors. The mobile assets can transmit signals to be received by the RFID tags/sensors and receive responses from the same. For the resources associated with the received responses, the mobile asset can estimate their location to be that of or proximate to the location of the mobile asset.

### CROSS-REFERENCE TO RELATED APPLICATIONS

This application claims priority to U.S. Patent Application Ser. No. 61/534,083, filed on Sep. 13, 2011, and U.S. Patent Application Ser. No. 61/597,253, filed on Feb. 10, 2012, which are hereby incorporated herein in their entireties by reference.

### BACKGROUND

With the ever-increasing number of resources managed, owned, or operated by various entities, new methods are needed for monitoring and tracking such resources.

### BRIEF SUMMARY

In general, embodiments of the present invention provide methods, apparatus, systems, computing devices, computing entities, and/or the like for monitoring resources.

In accordance with one aspect, a method for monitoring at least one resource is provided. In one embodiment, the method comprises (1) transmitting a request to be received by one or more radio identification (RFID) tags within a read range, wherein each of the one or more radio identification tags (a) is physically associated with a resource and (b) stores a unique resource identifier corresponding to the associated resource; (2) after transmitting the request to be received by the one or more RFID tags within the read range, receiving a response from at least one of the one or more RFID tags within the read range, wherein the response comprises the resource ID stored by the at least one of the one or more RFID tags; (3) determining an estimated location of mobile asset; and (4) transmitting the (a) unique resource identifier for the at least one of the one or more resources from which the response was received and (b) estimated location of the mobile asset.

In accordance with another aspect, a computer program product for monitoring at least one resource is provided. The computer program product may comprise at least one computer-readable storage medium having computer-readable program code portions stored therein, the computer-readable program code portions comprising executable portions configured to (1) transmit a request to be received by one or more radio identification (RFID) tags within a read range, wherein each of the one or more radio identification tags (a) is physically associated with a resource and (b) stores a unique resource identifier corresponding to the associated resource; (2) after transmitting the request within the read range to be received by the one or more RFID tags within the read range, receive a response from at least one of the one or more RFID tag within the read range, wherein the response comprises the resource ID stored by the RFID tag; (3) determine an estimated location of a mobile asset associated with the apparatus; and (4) transmit the (a) unique resource identifier for the at least one of the one or more resources from which the response was received and (b) estimated location of the mobile asset associated with the apparatus.

In accordance with yet another aspect, an apparatus comprising at least one processor and at least one memory including computer program code is provided. In one embodiment, the at least one memory and the computer program code may be configured to, with the processor, cause the apparatus to (1) transmit a request to be received by one or more radio identification (RFID) tags within a read range, wherein each of the one or more radio identification tags (a) is physically associated with a resource and (b) stores a unique resource identifier corresponding to the associated resource; (2) after transmitting the request within the read range to be received by the one or more RFID tags within the read range, receive a response from at least one of the one or more RFID tag within the read range, wherein the response comprises the resource ID stored by the RFID tag; (3) determine an estimated location of a mobile asset associated with the apparatus; and (4) transmit the (a) unique resource identifier for the at least one of the one or more resources from which the response was received and (b) estimated location of the mobile asset associated with the apparatus.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram of a system that can be used to practice various embodiments of the present invention.

FIG. 2 includes a diagram of a data collection device that may be used in association with certain embodiments of the present invention.

FIG. 3 is a schematic of a monitoring server in accordance with certain embodiments of the present invention.

FIG. 4 is a schematic of a mobile device in accordance with certain embodiments of the present invention.

FIGS. 5A and 5B are exemplary resources in accordance with certain embodiments of the present invention.

FIG. 6 is a diagram of a system that can be used to practice various embodiments of the present invention.

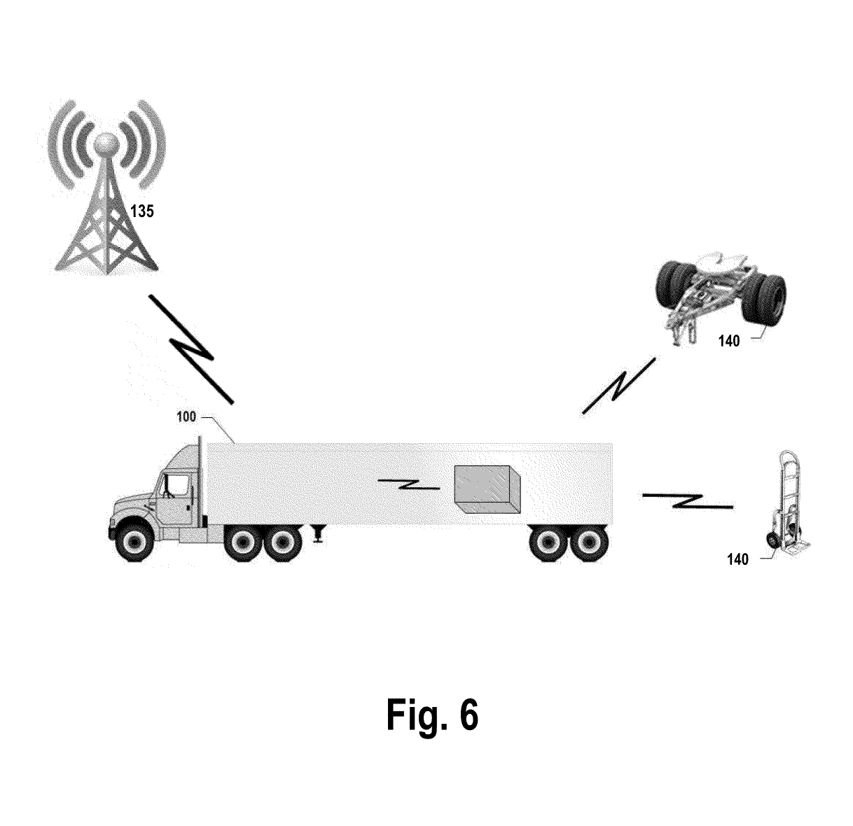

FIG. 7 is a flowchart illustrating operations and processes that can be used in accordance with various embodiments of the present invention.

FIGS. 8A, 8B, and 8C are exemplary resource records in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a non-volatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory VRAM, cache memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions on a computer-readable storage medium for execution. Such embodiments can produce specifically-configured machines performing the steps or operations specified in the block diagrams and flowchart illustrations. Accordingly, the block diagrams and flowchart illustrations support various combinations of embodiments for performing the specified steps or operations.

### II. EXEMPLARY SYSTEM ARCHITECTURE

The system may include one or more mobile assets 100, one or more mobile devices 105, one or more monitoring servers 110, one or more Global Positioning System (GPS) satellites 115, one or more networks 135, one or more resources 140, and/or the like. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like.

a. Exemplary Mobile Asset

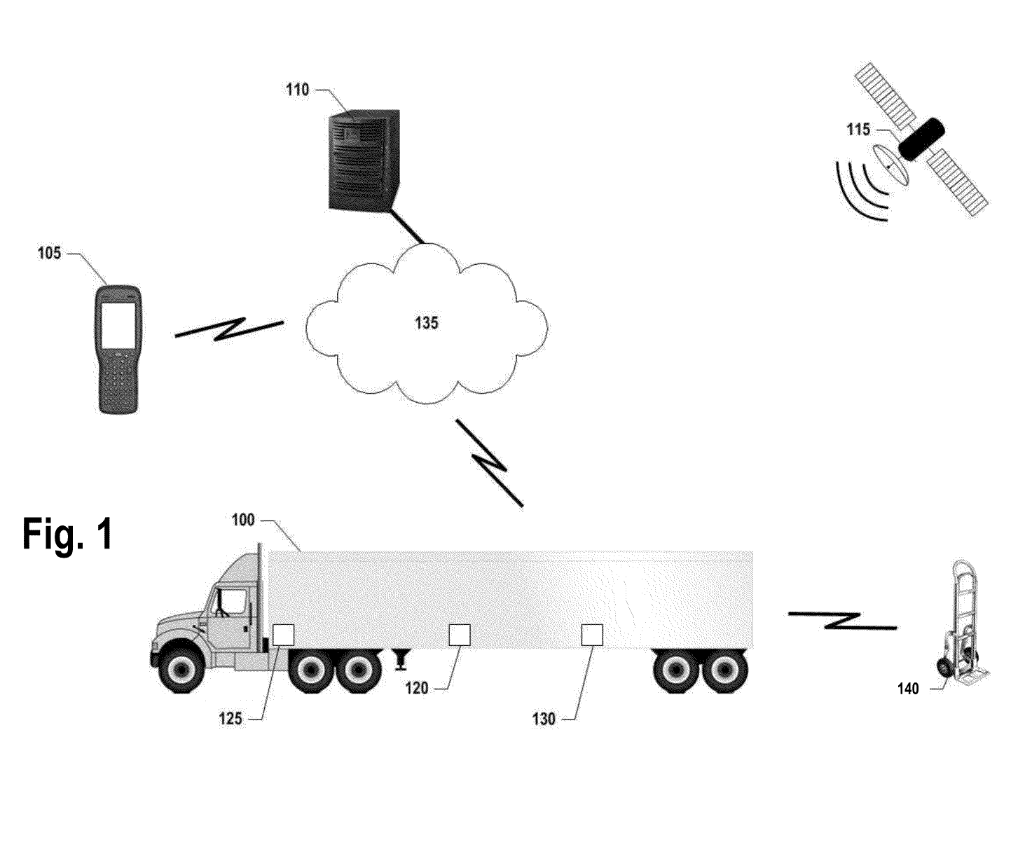

In various embodiments, a mobile asset 100 may be a tractor, a trailer, a tractor and trailer combination, a van, a flatbed truck, an aircraft-pushback tractor, a belt loader, a cargo loader, a deicer, a forklift, and/or the like. In one embodiment, each mobile asset 100 may be associated with a unique mobile asset identifier (such as a mobile asset ID) that uniquely identifies the mobile asset 120. The mobile asset 100 may be mobile in the sense that it may be able to move from one location to another under its own power. The unique mobile asset ID may include characters, such as numbers, letters, symbols, and/or the like. For example, an alphanumeric mobile asset ID (e.g., “1221A445533AS445”) may be associated with each mobile asset 100. FIG. 1 represents an embodiment in which the mobile asset 100 is a tractor, a trailer, or a tractor and trailer combination.

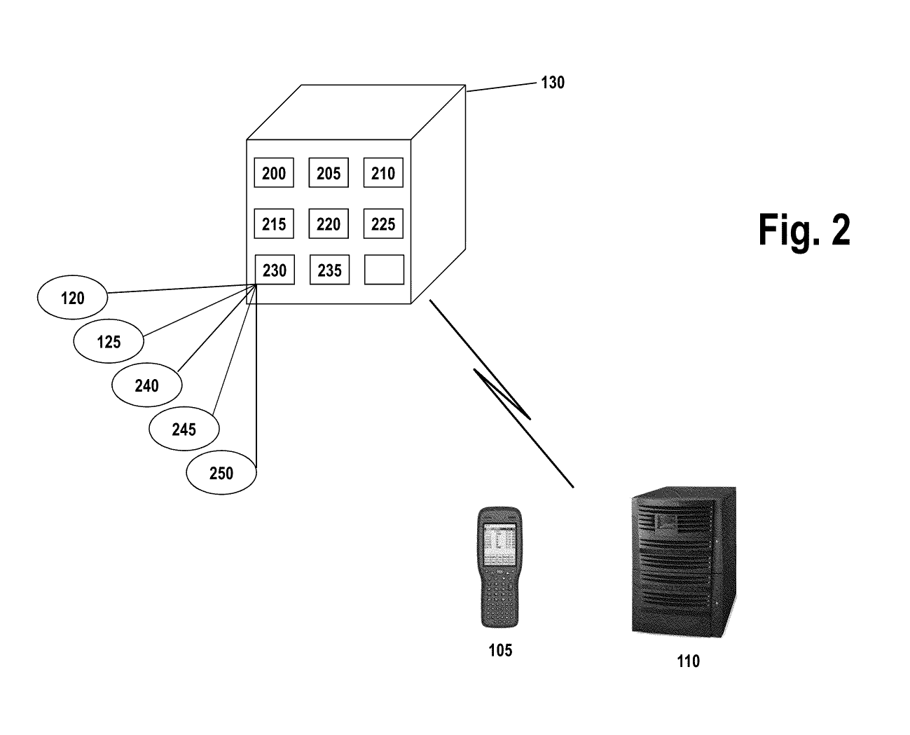

FIG. 1 provides one or more computing entities associated with the mobile asset 100, such as an information/data collection device 130 or other computing entities. FIG. 2 provides a block diagram of an exemplary information/data collection device 130 that may be attached, affixed, disposed upon, integrated into, or part of a mobile asset 100. The information/data collection device 130 may collect location and telematics information/data and transmit/send the information/data to the mobile device 105 and/or the monitoring server 110 via one of several communication methods.

In one embodiment, the information/data collection device 130 may include, be associated with, or be in communication with one or more processors 200, one or more location-determining devices or one or more location sensors 120 (e.g., Global Navigation Satellite System (GNSS) sensors), one or more telematics sensors 125, one or more real-time clocks 215, a J-Bus protocol architecture, one or more electronic control modules (ECM) 245, one or more communication ports 230 for receiving information/data from various sensors (e.g., via a CAN-bus), one or more communication ports 205 for transmitting/sending information/data, one or more radio frequency identification (RFID) tags/sensors 250, one or more power sources 220, one or more information/data radios 235 for communication with a variety of communication networks, one or more memory modules 210, and one or more programmable logic controllers (PLC) 225. It should be noted that many of these components may be located in the mobile asset 100 (e.g., tractor and/or trailer) but external to the information/data collection device 130.

In one embodiment, the one or more location sensors 120 may be one of several components in communication with or available to the information/data collection device 130. Moreover, the one or more location sensors 120 may be compatible with a Low Earth Orbit (LEO) satellite system or a Department of Defense (DOD) satellite system. Alternatively, triangulation may be used in connection with a device associated with a particular mobile asset and/or the mobile asset's operator and with various communication points (e.g., cellular towers or Wi-Fi access points) positioned at various locations throughout a geographic area to monitor the location of the mobile asset 100 (e.g., tractor and/or trailer) and/or its operator. The one or more location sensors 120 may be used to receive latitude, longitude, altitude, geocode, course, position, time, and/or speed information/data (e.g., location data). The one or more location sensors 120 may also communicate with the monitoring server 110, the information/data collection device 130, and/or similar network entities.

As indicated, in addition to the one or more location sensors 120, the information/data collection device 130 may include and/or be associated with one or more telematics sensors 125. For example, the telematics sensors 125 may include mobile asset sensors, such as engine, fuel, odometer, hubometer, tire pressure, location, weight, emissions, door, and speed sensors. The telematics information/data may include, but is not limited to, speed information/data, emissions information/data, RPM information/data, tire pressure information/data, oil pressure information/data, seat belt usage information/data, distance information/data, fuel information/data, idle information/data, and/or the like. The telematics sensors 125 may include environmental sensors, such as air quality sensors, temperature sensors, and/or the like. Thus, the telematics information/data may also include carbon monoxide (CO), nitrogen oxides (NOx), sulfur oxides (SOx), ozone (O₃), hydrogen sulfide (H₂S) and/or ammonium (NH₄) information/data, and/or meteorological data.

In one embodiment, the ECM 245 may be one of several components in communication with and/or available to the information/data collection device 130. The ECM 245, which may be a scalable and subservient device to the information/data collection device 130, may have information/data processing capability to decode and store analog and digital inputs from mobile asset systems and sensors. The ECM 245 may further have information/data processing capability to collect and present mobile asset information/data to the J-Bus (which may allow transmission to the information/data collection device 130), and output standard mobile asset diagnostic codes when received from a mobile asset's J-Bus-compatible on-board controllers 240 and/or sensors.

As indicated, a communication port 230 may be one of several components available in the information/data collection device 130 (or be in or as a separate computing entity). Embodiments of the communication port 230 may include an Infrared information/data Association (IrDA) communication port, an information/data radio, and/or a serial port. The communication port 230 may receive instructions for the information/data collection device 130. These instructions may be specific to the mobile asset 100 (e.g., tractor and/or trailer) in which the information/data collection device 130 is installed, specific to the geographical area in which the mobile asset 100 (e.g., tractor and/or trailer) will be traveling, and/or specific to the function the mobile asset 100 (e.g., tractor and/or trailer) serves within the fleet. In one embodiment, the information/data radio 235 may be configured to communicate with a wireless wide area network (WWAN), wireless local area network (WLAN), wireless personal area network (WPAN), or any combination thereof. For example, the information/data radio 235 may communicate via various wireless protocols, such as 802.11, general packet radio service (GPRS), Universal Mobile Telecommunications System (UMTS), Code Division Multiple Access 2000 (CDMA2000), CDMA20001x (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Via these communication standards and protocols, the information/data radio 235 (or other computing entity or communication interface associated with the mobile asset 100) can communicate with, power, and/or interrogate RFID tags/sensors 500. The communication with and/or interrogation of the RFID tags/sensors 500 may be used to extract information/data stored or collected by the RFID tags/sensors 500 (such as resource IDs). For example, an appropriate computing entity or communication interface of the mobile asset 100 can transmit/send a signal (e.g., a radio frequency (RF) signal) that prompts and/or powers RFID tags/sensors 500 within a geographical range (e.g., a read range) to provide information/data from the memory of the tags/sensors to the appropriate computing entity or communication interface of the mobile asset 100. For example, certain versions of Bluetooth may have a read range of up to 30 feet, while other versions of Bluetooth may have a read range of up to 100 feet. Similarly, Wi-Fi may have a read range of up to 120 feet indoors and 300 feet outdoors. As will be recognized, read ranges may vary based on the technology used and the environment in which they are used.

In one embodiment, the appropriate computing entity or communication interface of the mobile asset 100 (e.g., tractor and/or trailer) can transmit/send an RF signal/request on a periodic, continuous, or regular basis, such that RFID tags/sensors 500 within the read range receive the RF signal/request when within the read range. In another embodiment, an appropriate computing entity or communication interface of a mobile asset 100 (e.g., tractor and/or trailer) can transmit/send an RF signal/request in response to a signal triggering event. For example, in one embodiment, a signal triggering event may include depressing a button that instructs the appropriate computing entity or communication interface of the mobile asset 100 (e.g., tractor and/or trailer) to transmit/send an RF signal/request. In another embodiment, the RF signal/request can be transmitted/sent “on-demand” if used appropriately with motion sensors, or the like, for recognizing the proximity of mobile assets 100 or resources 140. In yet another embodiment, the RF signal/request can be transmitted/sent in response to the mobile asset 100 (e.g., tractor and/or trailer) entering or exiting a geofenced area.

b. Exemplary Monitoring Server

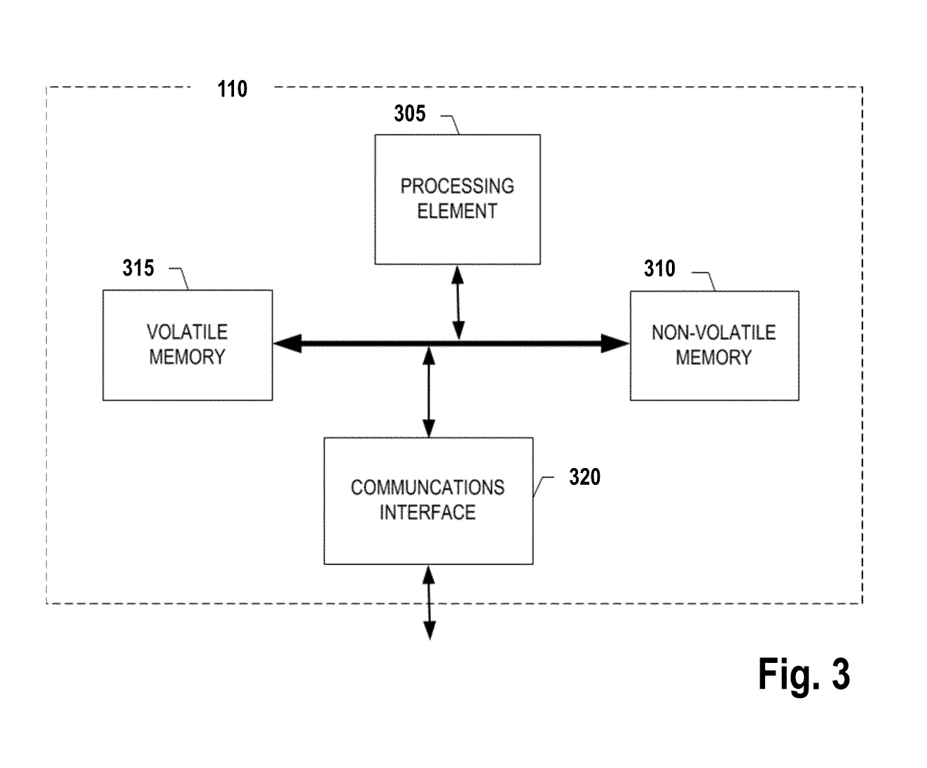

FIG. 3 provides a schematic of a monitoring server 110 according to one embodiment of the present invention. In general, the term server may refer to, for example, one or more computers, computing devices, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the monitoring server 110 may also include one or more communications interfaces 320 for communicating with various computing entities, such as by communicating data, content, information, and/or similar terms used herein interchangeably that can be transmitted, received, operated on, processed, displayed, stored, and/or the like. For instance, the monitoring server 110 may communicate with the mobile assets 100, mobile devices 105, and/or the like.

As shown in FIG. 3, in one embodiment, the monitoring server 110 may include or be in communication with one or more processing elements 305 (also referred to as processors, processing circuitry, and/or similar terms used herein interchangeably) that communicate with other elements within the monitoring server 110 via a bus, for example. As will be understood, the processing element 305 may be embodied in a number of different ways. For example, the processing element 305 may be embodied as one or more complex programmable logic devices (CPLDs), microprocessors, multi-core processors, coprocessing entities, application-specific instruction-set processors (ASIPs), and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in volatile or non-volatile media or otherwise accessible to the processing element 305. As such, whether configured by hardware or computer program products, or by a combination thereof, the processing element 305 may be capable of performing steps or operations according to embodiments of the present invention when configured accordingly.

In one embodiment, the monitoring server 110 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 310 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, information/data, applications, programs, program modules, scripts, source code, object code, byte code, compiled code, interpreted code, machine code, executable instructions, and/or the like. The term database, database instance, database management system, and/or similar terms used herein interchangeably may refer to a structured collection of records or information/data that is stored in a computer-readable storage medium, such as via a relational database, hierarchical database, and/or network database.

In one embodiment, the monitoring server 110 may further include or be in communication with volatile media (also referred to as volatile storage, memory, memory storage, memory circuitry and/or similar terms used herein interchangeably). In one embodiment, the volatile storage or memory may also include one or more volatile storage or memory media 315 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, information/data, applications, programs, program modules, scripts, source code, object code, byte code, compiled code, interpreted code, machine code, executable instructions, and/or the like being executed by, for example, the processing element 305. Thus, the databases, database instances, database management systems, information/data, applications, programs, program modules, scripts, source code, object code, byte code, compiled code, interpreted code, machine code, executable instructions, and/or the like may be used to control certain aspects of the operation of the monitoring server 110 with the assistance of the processing element 305 and operating system.

As indicated, in one embodiment, the monitoring server 110 may also include one or more communications interfaces 320 for communicating with various computing entities, such as by communicating information/data, content, information, and/or similar terms used herein interchangeably that can be transmitted, received, operated on, processed, displayed, stored, and/or the like. For instance, the monitoring server 110 may communicate with computing entities or communication interfaces of the mobile asset 100 (e.g., tractor and/or trailer), the mobile device 105, and/or the like. Such communication may be executed using a wired information/data transmission protocol, such as fiber distributed information/data interface (FDDI), digital subscriber line (DSL), Ethernet, asynchronous transfer mode (ATM), frame relay, information/data over cable service interface specification (DOCSIS), or any other wired transmission protocol. Similarly, the monitoring server 110 may be configured to communicate via wireless external communication networks using any of a variety of protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol. Although not shown, the monitoring server 110 may include or be in communication with one or more input elements, such as a keyboard input, a mouse input, a touch screen/display input, audio input, pointing device input, joystick input, keypad input, and/or the like. The monitoring server 110 may also include or be in communication with one or more output elements (not shown), such as audio output, video output, screen/display output, motion output, movement output, and/or the like.

As will be appreciated, one or more of the monitoring server's 110 components may be located remotely from other monitoring server 110 components, such as in a distributed system. Furthermore, one or more of the components may be combined and additional components performing functions described herein may be included in the monitoring server 110. Thus, the monitoring server 110 can be adapted to accommodate a variety of needs and circumstances.

c. Exemplary Mobile Device

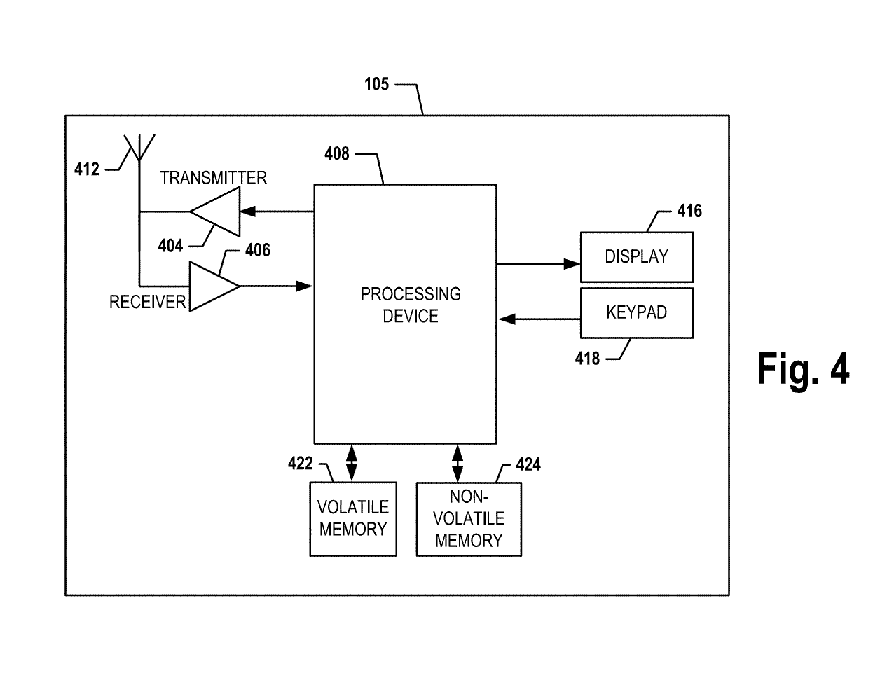

FIG. 4 provides an illustrative schematic representative of a mobile device 105 (e.g., a mobile computing entity) that can be used in conjunction with embodiments of the present invention. The device is mobile in the sense that it can be easily moved from one location to another. Mobile devices 105 can be operated by various parties. As shown in FIG. 4, the mobile device 105 can include an antenna 412, a transmitter 404 (e.g., radio), a receiver 406 (e.g., radio), and a processing element 408 that provides signals to and receives signals from the transmitter 404 and receiver 406, respectively.

The signals provided to and received from the transmitter 404 and the receiver 406, respectively, may include signaling information/data in accordance with an air interface standard of applicable wireless systems. In this regard, the mobile device 105 may be capable of operating with one or more air interface standards, communication protocols, modulation types, and access types. More particularly, the mobile device 105 may operate in accordance with any of a number of wireless communication standards and protocols. In a particular embodiment, the mobile device 105 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 105 can communicate with, power, and/or interrogate RFID tags/sensors 500. The communication with and/or interrogation of the RFID tags/sensors 500 may be used to extract information/data stored or collected by the RFID tags/sensors 500 (such as resource IDs). For example, the mobile device 105 can transmit a signal (e.g., a radio frequency (RF) signal) that prompts and/or powers an RFID tag/sensor 500 within a geographical range (e.g., the read range) to provide information/data from the memory of the RFID tag/sensor 500 to the appropriate computing entity or communication interface of the mobile asset 100 (e.g., tractor and/or trailer).

In one embodiment, the mobile device 105 can transmit an RF signal/request on a periodic, continuous, or regular basis, such that RFID tags/sensors 500 within the read range receive the RF signals/requests when within the read range of the appropriate computing entity or communication interface of the mobile device 105. In another embodiment, the mobile device 105 can transmit an RF signal/request in response to a signal triggering event. For example, in one embodiment, a signal triggering event may include depressing a button that instructs the mobile device 105 to transmit/send an RF signal/request. In another embodiment, the RF signal/request can be transmitted “on-demand” if used appropriately with motion sensors, or the like, for recognizing the proximity of mobile assets 100 or resources 140. In yet another embodiment, the RF signal/request can be transmitted/sent in response to the mobile device 105 entering or exiting a defined geofence.

Via these communication standards and protocols, the mobile device 105 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The mobile device 105 can also download changes, add-ons, and updates, for instance, to its firmware, software (e.g., including executable instructions, applications, program modules), and operating system.

According to one embodiment, the mobile device 105 may include a location determining device and/or functionality. For example, the mobile device 105 may include a GPS module adapted to acquire, for example, latitude, longitude, altitude, geocode, course, and/or speed data. In one embodiment, the GPS module acquires information/data, sometimes known as ephemeris information/data, by identifying the number of satellites in view and the relative positions of those satellites.

The mobile device 105 may also comprise a user interface (that can include a display 416 coupled to a processing element 408) and/or a user input interface (coupled to a processing element 408). The user input interface can comprise any of a number of devices allowing the mobile device 105 to receive information/data, such as a keypad 418 (hard or soft), a touch display, voice or motion interfaces, or other input device. In embodiments including a keypad 418, the keypad 418 can include (or cause display of) the conventional numeric (0-9) and related keys (#, *), and other keys used for operating the mobile device 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 105 can also include volatile storage or memory 422 and/or non-volatile storage or memory 424, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management systems, information/data, applications, programs, program modules, scripts, source code, object code, byte code, compiled code, interpreted code, machine code, executable instructions, and/or the like to implement the functions of the mobile device 105.

d. Exemplary Resources

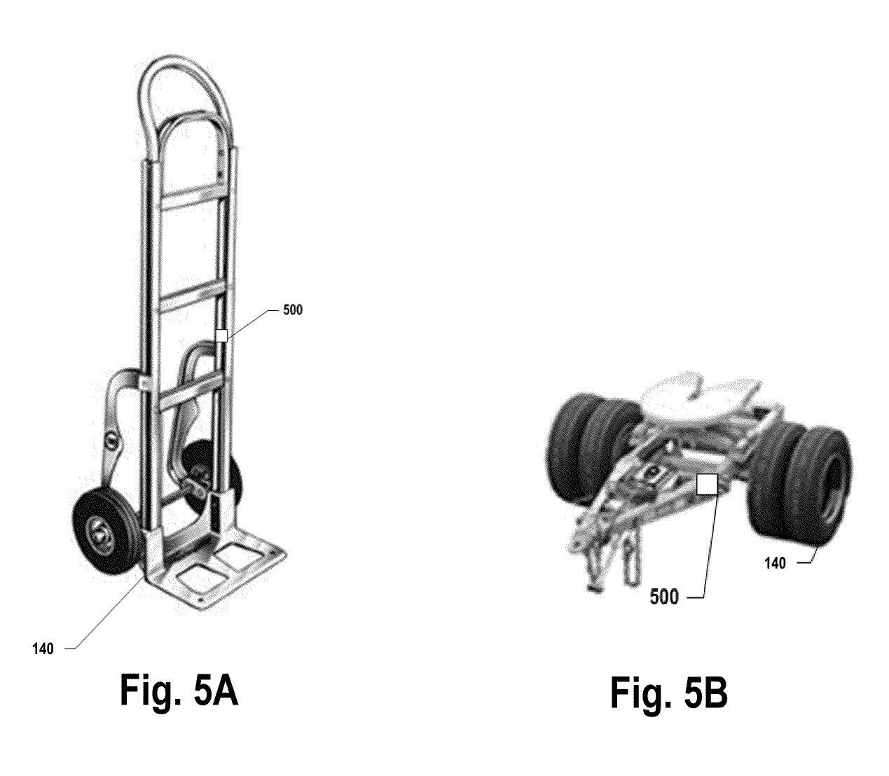

In various embodiments, a resource 140 may be any dolly, forklift, stacker truck, side loader, high/low, pallet truck, hand truck, handcart, chassis, reusable pouch, generator, portable light, boom lift, cargo container, item being transported, item and its container being transported, and/or the like. Each resource 140 may be associated with a unique resource identifier (such as a resource ID) that uniquely identifies the resource. The unique resource ID may include characters, such as numbers, letters, symbols, and/or the like. For example, an alphanumeric resource ID (e.g., “7221A445533AS449”) may be associated with each resource 140. FIGS. 1 and 5 represent an embodiment in which resources 140 are a dolly and a chassis.

In one embodiment, each resource 140 may have an RFID tag/sensor 500 attached or affixed thereto that stores the corresponding resource ID. Such an RFID tag/sensor 500 can be placed inside a resource 140, affixed to an outer surface of a resource 140, or it can be positioned directly on an item within a resource 140, for example. The RFID tags/sensors 500 may be passive RFID tags/sensors 500, active RFID tags/sensors 500, semi-active RFID tags/sensors 500, battery-assisted passive RFID tags/sensors 500, and/or the like. Thus, the RFID tags/sensors 500 can include some or all of the following components: one or more input interfaces for receiving information/data, one or more output interfaces for transmitting information/data, a processor, a clock, memory modules, and a power source.

In addition to storing a resource ID, in one embodiment, each RFID tag/sensor 500 associated with a resource 140 can be used to collect environmental information. The RFID tag/sensor 500 can be capable of sensing one or more environmental information/data, such as temperature information/data, pressure information/data, radiological information/data, vacuum information/data, vibration information/data, shock information/data, humidity information/data, moisture information/data, light information/data, air information/data, and/or the presence or absence of chemical information/data. Such information/data may be collected on a periodic, continuous, or regular basis or in response to certain triggers. For example, RFID tags/sensors 500 capable of collecting data and/or detecting changes are described in U.S. Pat. No. 6,294,997, which is hereby incorporated by reference.

Via various communication standards and protocols, the RFID tags/sensors 500 on resources 140 can be communicated with and/or interrogated. For example, an appropriate computing entity (e.g., mobile device 105 or a computing entity or communication interface associated with a mobile asset 100) can communicate with and/or interrogate the RFID tags/sensors 500 using multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol. The communication with and/or interrogation of the RFID tags/sensors 500 may be used to extract information/data stored or collected by the RFID tags/sensors 500 (e.g., resource IDS and/or information/data). For example, when within a read range, an RFID tag/sensor 500 associated with a resource can receive an RF signal/request that prompts and/or powers the RFID tag/sensor 500 to provide information/data from the memory of the tag/sensor to the computing entity or communication interface that transmitted the signal. As previously discussed, such RF signals/requests can be received on a periodic, continuous, or regular basis, such that RFID tags/sensors 500 within the read range receive the RF signals/requests when within the read range. In another embodiment, though, the RF signals/requests can be received in response to a triggering event that prompted a computing entity to transmit the signals/requests. In response to such signals/requests, the RFID tags/sensors 500 can provide information/data stored or collected by the RFID tags/sensors 500, such as the corresponding resource IDs.

### III. EXEMPLARY SYSTEM OPERATION

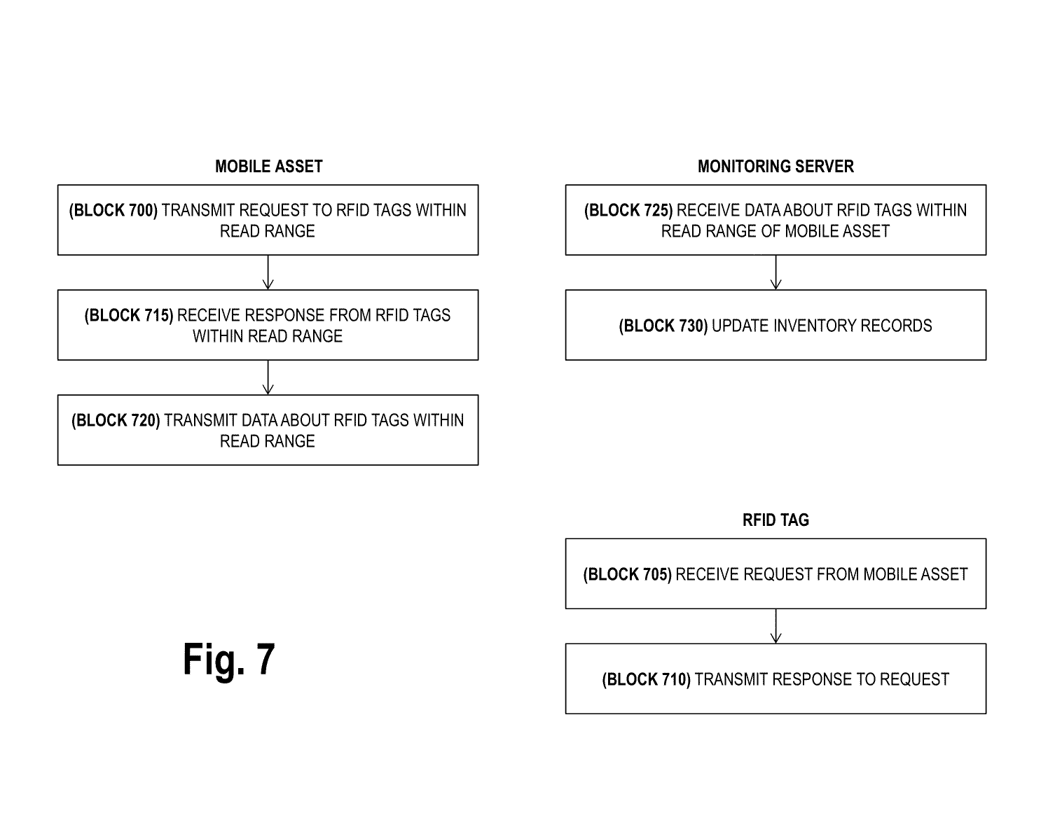

Reference will now be made to FIG. 7. FIG. 7 is a flowchart illustrating operations and processes that may be performed for monitoring resources 140 using RFID technologies.

a. Transmission of Signal to RFID Tag

In one embodiment, as indicated in Block 700 of FIG. 7, an appropriate computing entity (e.g., mobile device 105 or computing entity or communication interface associated with a mobile asset 100) can transmit/send a signal/request to be received by RFID tags/sensors 500 within the computing entity's read range. The signal/request can be transmitted/sent on a periodic, continuous, or regular basis or in response to certain triggers.

### 1. Periodic, Continuous, or Regular Transmission of Signal

As indicated, an appropriate computing entity (e.g., mobile device 105 or computing entity or communication interface associated with a mobile asset 100) can transmit/send a signal/request to be received by RFID tags/sensors 500 within the computing entity's read range on a periodic, continuous, or regular basis. For example, in one embodiment, an appropriate computing entity (e.g., mobile device 105 or computing entity or communication interface associated with a mobile asset 100) can transmit/send a signal/request to be received by RFID tags/sensors 500 within the computing entity's read range every 5 seconds, every 10 seconds, every 60 seconds, every 10 minutes, every 60 minutes, and/or the like.

As previously noted, the read range may vary based on the particular technology being used. For example, in an embodiment using Bluetooth, the read range of a computing entity (e.g., mobile device 105 or computing entity or communication interface associated with a mobile asset 100) transmitting/sending a Bluetooth signal/request may be up to 30 feet. Thus, RFID tags/sensors within that 30-foot read range may receive the signal/request. Other technologies and protocols may reduce or increase the read range. These technologies and protocols include GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, USB protocols, and/or any other wireless protocol.

### 2. Geofence-Based Transmission of Signal

As indicated, an appropriate computing entity (e.g., mobile device 105 or computing entity or communication interface associated with a mobile asset 100) can transmit/send a signal/request to be received by RFID tags/sensors 500 within the computing entity's read range in response to certain triggers. For example, in one embodiment, an appropriate computing entity (e.g., mobile device 105 or computing entity or communication interface associated with a mobile asset 100) can transmit/send a signal/request to be received by RFID tags/sensors 500 within the computing entity's read range in response to (e.g., after) a determination that the mobile asset 100 entered or exited a geofenced area. Such an embodiment is described below.

i. Geographic Areas

In one embodiment, mobile assets 100 may be associated with, assigned to, or traverse one or more geographic areas. In one embodiment, the geographic areas may correspond to countries, regions, states, counties, cities, towns, and/or the like. For example, geographic areas may be defined around the United States, the state of Georgia, Gwinnett County in the state of Georgia, and/or the like. In one embodiment, the geographic areas may correspond to travel paths (e.g., roads, avenues, highways, streets, toll roads, ways, interstates, bridges, freeways, etc.). For example, a geographic area may be defined around a public road (e.g., substantially around I-285) or a portion of a public road (e.g., exit and/or entrance ramps on I-75 in Georgia or throughout the U.S. and portions of I-75). As will be recognized, geographic areas may also correspond to private land areas, vehicle staging areas, parking lots (e.g., at malls or other establishments), driveways, and/or the like.

According to various embodiments of the present invention, a geographic area may overlap or reside wholly within another geographic area. Geographic areas may, for example, be as large as an entire country, region, state, county, city, or town (or larger). According to various embodiments, the geographic areas need not be continuous. In other words, a geographic area may specifically exclude an area that would otherwise fall within the geographic area (e.g., such that the geographic area forms a donut or other shape around the excluded area).

The geographic areas may be defined based on any number and/or combination of factors including, but not limited to, those described above. The foregoing examples are therefore provided for exemplary purposes only and should not be taken in any way as limiting embodiments of the present invention to the examples provided.

ii. Defined Geofences

Map vendors, such as Tele Atlas® and NAVTEQ®, provide digitized maps to a variety of clients for different purposes. For example, such companies may provide digitized maps to: (a) Internet websites for providing driving directions to consumers; (b) cellular companies to include in phones and personal digital assistants; (c) government agencies (e.g., the United States Department of Agriculture and Environmental Protection Agency) for use in their respective government functions; (d) transportation and logistics companies; and (e) various other entities for a variety of reasons.

In one embodiment, using such digitized maps, a computing entity (e.g., the data collection device 130, mobile device 105, and/or monitoring server 110) may be used to define one or more geofences. The geofences may be defined to surround countries, regions, states, counties, cities, towns, neighborhoods, off-road areas (e.g., areas without paved roads), private land areas, parking lots, and/or the like. Further, one or more geofences may be defined to surround travel paths (e.g., roads, avenues, highways, streets, toll roads, ways, interstates, freeways) or parts of travel paths (e.g., such as bridges, school zones, intersections, exit and entrance ramps, grades above a certain percentage, high-traffic areas, high-accident areas, increased travel speed areas, travel paths with certain types of pavement, and/or the like). The geofences may be defined, for example, by the latitude and longitude coordinates associated with various points along the perimeter of the geographic area. Alternatively, geofences may be defined based on latitude and longitude coordinates of the center, as well as the radius, of the geographic area. Geofences may be as large as an entire country, region, state, county, city, or town (or larger) or as small as an intersection (or smaller). The geographic areas, and therefore the geofences, may be any shape including, but not limited to, a circle, square, rectangle, an irregular shape, and/or the like. Moreover, the geofenced areas need not be the same shape or size. Accordingly, any combination of shapes and sizes may be used in accordance with embodiments of the present invention.

iii. Transmission of Signal

In one embodiment, once at least one geofence has been defined, the coordinates (or similar methods for defining the geofenced areas) may be stored in a database associated with, for example, the data collection device 130, mobile device 105, and/or monitoring server 110. Thus, as the mobile asset 100 (e.g., tractor and/or trailer) travels or as the mobile device 105 is moved, the estimated location of the mobile asset 100 (e.g., tractor and/or trailer) or mobile device 105 can trigger/initiate certain events based on the mobile asset's 100 or mobile device's 105 estimated location. For instance, entering and/or exiting a geofenced area may be used to cause an appropriate computing entity (e.g., mobile device 105 or computing entity or communication interface associated with a mobile asset 100) to transmit/send a signal/request to be received by RFID tags/sensors 500 within the computing entity's read range in response to entering or exiting a geofenced area.

Operatively, the estimated location of a mobile asset 100 (e.g., tractor and/or trailer) or a mobile device 105 can be monitored and/or determined on a regular, continuous, or periodic basis or in response to certain triggers. Generally, the estimated location of a mobile asset 100 (e.g., tractor and/or trailer) or a mobile device 105 can be monitored by any of a variety of computing entities, including the data collection device 130, the mobile device 105, the monitoring server 110, and/or any other appropriate computing entity. For example, as noted above, the mobile asset's 100 (or the mobile device's 105) estimated location at a particular time may be determined with the aid of location-determining devices, location sensors 120 (e.g., GNSS sensors), and/or other telemetry location services (e.g., cellular assisted GPS or real time location system or server technology using received signal strength indicators from a Wi-Fi network).

In one embodiment, by using the mobile asset's 100 estimated location, a computing entity (data collection device 130, mobile device 105, or monitoring server 110) can determine, for example, when the mobile asset 100 enters a defined geofence (e.g., a geofenced area). In one embodiment, in response to (e.g., after) a determination that a mobile asset 100 has entered a defined geofenced area, an appropriate computing entity (e.g., mobile device 105 or computing entity or communication interface associated with a mobile asset 100) can transmit/send a signal/request to be received by RFID tags/sensors 500 within the computing entity's read range once or on a periodic, continuous, or regular basis while within the geofenced area. After the mobile asset 100 (e.g., tractor and/or trailer) has entered the geofenced area, the estimated location of the mobile asset 100 can continue to be monitored by any of a variety of computing entities. By using the mobile asset's 100 estimated location, a computing entity can determine, for example, when the mobile asset 100 (e.g., tractor and/or trailer) exits the defined geofenced area, which may trigger the appropriate computing entity to cease transmission of the signals/requests.

In another embodiment, by using the mobile asset's 100 estimated location, a computing entity (data collection device 130, mobile device 105, or monitoring server 110) can determine, for example, when the mobile asset 100 exits a defined geofence (e.g., a geofenced area). In one embodiment, in response to (e.g., after) a determination that a mobile asset 100 has exited a defined geofenced area, an appropriate computing entity (e.g., mobile device 105 or computing entity or communication interface associated with a mobile asset 100) can transmit/send a signal/request to be received by RFID tags/sensors 500 within the computing entity's read range once or on a periodic, continuous, or regular basis while outside the geofenced area. After the mobile asset 100 (e.g., tractor and/or trailer) has exited the geofenced area, the estimated location of the mobile asset 100 can continue to be monitored by any of a variety of computing entities. By using the mobile asset's 100 estimated location, a computing entity can determine, for example, when the mobile asset 100 (e.g., tractor and/or trailer) enters the defined geofenced area, which may trigger the appropriate computing entity to cease transmission of the signals/requests.

As previously noted, the read range may vary based on the particular technology being used. For example, in an embodiment using Bluetooth, the read range of a computing entity (e.g., a data collection device 130, a mobile device 105) transmitting/sending a Bluetooth signal/request may be up to 30 feet. Thus, RFID tags/sensors within that read range may receive the signal/request. Other technologies and protocols may reduce or increase the read range, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, USB protocols, and/or any other wireless protocol.

c. Data from RFID Tag

In one embodiment, in response to (e.g., after) an appropriate computing entity (e.g., mobile device 105 or computing entity or communication interface associated with a mobile asset 100) transmitting/sending a signal/request to be received by RFID tags/sensors 500 within the computing entity's read range, RFID tags/sensors 500 within the read range can receive the signal/request (Block 705 of FIG. 7). In some embodiments, receipt of the signal/request can be sufficient to power RFID tags/sensors 500 to transmit/send responses to the signal/request. In other embodiments, the RFID tags/sensors 500 may include a power source such that the RFID tags/sensors 500 can transmit/send responses to the signal/request based on their own power. In any case, RFID tags/sensors 500 that receive the signal/request can transmit/send a response to the appropriate computing entity (Block 710 of FIG. 7).

In one embodiment, the responses from the RFID tags/sensors 500 may include minimal information. For example, each RFID tag/sensor within the read range may transmit/send a response that includes the resource ID for the resource 140 to which the RFID tag/sensor is affixed. By way of example, an RFID tag/sensor affixed to a dolly assigned resource ID 7221A445533AS449 may respond to the signal/request by transmitting/sending a response with its resource ID (7221A445533AS449). An RFID tag/sensor affixed to a chassis assigned resource ID 7221A445533AS412 may respond to the signal/request by transmitting/sending a response with its resource ID (7221A445533AS412). And an RFID tag/sensor attached to or enclosed within a high value item being transported and assigned resource ID 7221A445533AS466 may respond to the signal/request by transmitting/sending a response with its resource ID (7221A445533AS466). Such responses may include other information as well, including the type of resource associated with the resource ID (e.g., dolly, chassis, high value item). As previously described, the types of resources may also include forklifts, stacker trucks, side loaders, high/lows, pallet trucks, hand trucks, handcarts, reusable pouches, generators, portable lights, boom lifts, cargo containers, items being transported, items and their containers being transported, and/or the like.

In one embodiment, in addition to the resource ID, the RFID tags/sensors 500 can also send/transmit environmental information/data as part of the responses. The environmental information/data may include temperature information/data, pressure information/data, radiological information/data, vacuum information/data, vibration information/data, shock information/data, humidity information/data, moisture information/data, light information/data, air information/data, and/or the presence or absence of chemical information/data collected from the environment surrounding the RFID tag/sensor.

In one embodiment, the appropriate computing entity (e.g., mobile device 105 or computing entity or communication interface associated with a mobile asset 100) can receive the responses transmitted/sent by the RFID tags/sensors 500 (Block 710 of FIG. 7) within its read range. Continuing with the above example, the appropriate computing entity (e.g., mobile device 105 or computing entity or communication interface associated with a mobile asset 100) can receive a response with resource ID 7221A445533AS449 (e.g., a response from dolly 7221A445533AS449), a response with resource ID 7221A445533AS412 (e.g., a response from chassis 7221A445533AS412), and a response with resource ID 7221A445533AS466 (e.g., a response from high value item 7221A445533AS466). Based on the received responses, the appropriate computing entity (e.g., mobile device 105 or computing entity or communication interface associated with a mobile asset 100) can determine that the three resources 140 from which responses are received are within the corresponding read range. Thus, the computing entity (e.g., mobile device 105 or computing entity or communication interface associated with a mobile asset 100) can determine that the dolly 7221A445533AS449, chassis 7221A445533AS412, and high value item 7221A445533AS466 are all within the read range of the computing entity (e.g., mobile device 105 or computing entity or communication interface associated with a mobile asset 100). This information/data can then be used to update the estimated location of each resource 140. That is, resources 140 within a computing entity's read range are necessarily proximate the computing entity's location with a tolerance covering the read range.

In one embodiment, to update the estimated location of resources 140 within a computing entity's read range, the computing entity can determine the estimated location of the mobile asset 100 associated with the computing entity (e.g., tractor and/or trailer) or itself as the mobile device 105. Such a determination can be made before, after, or even simultaneously to transmitting/sending the signal/request to RFID tags/sensors 500 within the read range. For example, the estimated location of a mobile asset 100 (e.g., tractor and/or trailer) or a mobile device 105 can be monitored or determined by any of a variety of computing entities, including the data collection device 130, the mobile device 105, the monitoring server 110, and/or any other appropriate computing entity. As noted above, the mobile asset's 100 (or the mobile device's 105) location at a particular time may be determined with the aid of location-determining devices, location sensors 120 (e.g., GNSS sensors), and/or other telemetry location services (e.g., cellular assisted GPS or real time location system or server technology using received signal strength indicators from a Wi-Fi network). Continuing with above example, the estimated location of the mobile asset 100 (e.g., tractor and/or trailer) or mobile device 105 may be determined to be at or proximate 33.787227, −84.383215. In one embodiment, this determination can also be associated with a time stamp representative of when the determination was made or when the data was collected: 2012-12-05 21:18:18Z. This information/data can then be used to update the estimated location of each resource 140.

With the estimated location of the mobile asset 100 or mobile device 105, an appropriate computing entity (e.g., mobile device 105 or computing entity or communication interface associated with a mobile asset 100) can transmit/send the relevant information/data to the monitoring server 110 (Block 720 of FIG. 7). For instance, a computing entity or communication interface associated with a mobile asset 100 can transmit/send the corresponding mobile asset ID, the estimated location and time stamp, and the resource IDs of resources 140 within the mobile asset's 100 read range. Continuing with the above example, a computing entity or communication interface associated with a mobile asset 100 can transmit/send information/data representative of its mobile asset ID 1221A445533AS445, the mobile asset's estimated location (33.787227, −84.383215 at 2012-12-05 21:18:18Z), and the resource IDs of dolly 7221A445533AS449, chassis 7221A445533AS412, and high value item 7221A445533AS466. As previously noted, in one embodiment, the resource type may also be include in the responses. This information/data can be transmitted to the monitoring server 110. A sample message from an appropriate computing entity (e.g., mobile device 105 or computing entity or communication interface associated with a mobile asset 100) to the monitoring server is provided below.

Sample Message

```
<?xml version=“1.0” encoding=“utf-8”?>
<ResourceUpdate xmlns:xsi=“http://www.w3.org/2001/XMLSchema-instance”>
  <MobileAsset>
    <MobileAssetID>1221A445533AS445</MobileAssetID>
    <MobileAssetLocation>33.787227,−84.383215</MobileAssetLocation>
    <MobileAssetLocationTime>2012-12-05,21:18:18Z</MobileAssetLocationTime>
  </MobileAsset>
  <Resource>
    <ResourceID>7221A445533AS449</ResourceID>
    <ResourceLocation>33.787227,−84.383215</ResourceLocation>
    <ResourceLocationTime>2012-12-05,21:18:18Z</ResourceLocationTime>
  </Resource>
  <Resource>
    <ResourceID>7221A445533AS412</ResourceID>
    <ResourceLocation>33.787227,−84.383215</ResourceLocation>
    <ResourceLocationTime>2012-12-05,21:18:18Z</ResourceLocationTime>
  </Resource>
  <Resource>
    <ResourceID>7221A445533AS466</ResourceID>
    <ResourceLocation>33.787227,−84.383215</ResourceLocation>
    <ResourceLocationTime>2012-12-05,21:18:18Z</ResourceLocationTime>
  </Resource>
</ResourceUpdate >
```

d. Update Inventory

In one embodiment, the monitoring server 110 can receive information/data from the various computing entities (Block 725 of FIG. 7) to update inventory records and other records associated with mobile assets 100 and resources 140. Continuing with the above example, the monitoring server 110 can receive the above message. That is, the monitoring server 110 can receive information/data representative of (1) the mobile asset ID 1221A445533AS445 and the mobile asset's estimated location and corresponding time (33.787227, −84.383215 at 2012-12-05 21:18:18Z); (2) the resource ID 7221A445533AS449 and the resource's 140 estimated location and corresponding time (33.787227, −84.383215 at 2012-12-05 21:18:18Z); (3) the resource ID 7221A445533AS412 and the resource's 140 estimated location and corresponding time (33.787227, −84.383215 at 2012-12-05 21:18:18Z); and (4) the resource ID 7221A445533AS466 and the resource's 140 estimated location and corresponding time (33.787227, −84.383215 at 2012-12-05 21:18:18Z).

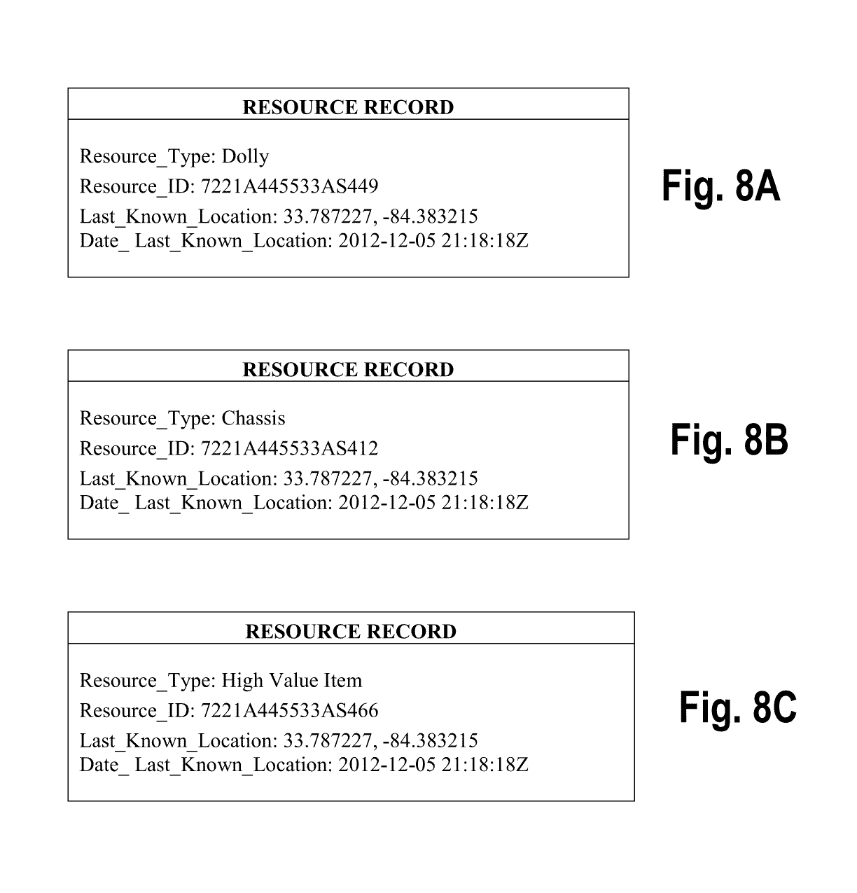

After the monitoring server 110 receives the information/data, the monitoring server 110 can update inventory records and other records in accordance with the received information. For example, FIGS. 8A, 8B, and 8C show records for each resource 140 that can be updated with the last known location (Last_Known_Location) and the date of the last known location (Date_Last_Known_Location). As will be recognized, a variety of other techniques and approaches can be used to adapt to various needs and circumstances.

These features allow for the locations of various resources 140 to be monitored and tracked using RFID technology. In various embodiments, this can provide for certain benefits. In one embodiment, the physical audit of the resources 140 and inventory reconciliation can be eliminated. Also, by using an automated approach, personnel time in auditing and reconciling the resources 140 can provide for a more efficient work environment.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for monitoring at least one resource, the method comprising:
transmitting, via one or more processors associated with a mobile asset, a request to be received by one or more radio identification (RFID) tags within a read range, wherein each of the one or more radio identification tags (a) is physically associated with a resource and (b) stores a unique resource identifier corresponding to the associated resource;
after transmitting the request to be received by the one or more RFID tags within the read range, receiving, via the one or more processors associated with the mobile asset, a response from at least one of the one or more RFID tags within the read range, wherein the response comprises the resource ID stored by the at least one of the one or more RFID tags;
determining, via the one or more processors associated with the mobile asset, an estimated location of mobile asset; and
transmitting, via the one or more processors associated with the mobile asset, the (a) unique resource identifier for the at least one of the one or more resources from which the response was received and (b) estimated location of the mobile asset.

2. The method of claim 1 further comprising updating an inventory record to reflect the estimated location of the mobile asset as the estimated location of the resource.

3. The method of claim 1, wherein the request from the mobile asset is transmitted after a determination that the mobile asset entered a geofenced area.

4. The method of claim 1, wherein the request from the mobile asset is transmitted after a determination that the mobile asset exited a geofenced area.

5. The method of claim 1, wherein the request from the mobile asset is transmitted on a periodic basis.

6. The method of claim 1, wherein the request from the mobile asset is transmitted via Bluetooth.

7. An apparatus comprising at least one processor and at least one memory including computer program code, the at least one memory and the computer program code configured to, with the processor, cause the apparatus to at least:
transmit a request to be received by one or more radio identification (RFID) tags within a read range, wherein each of the one or more radio identification tags (a) is physically associated with a resource and (b) stores a unique resource identifier corresponding to the associated resource;
after transmitting the request within the read range to be received by the one or more RFID tags within the read range, receive a response from at least one of the one or more RFID tag within the read range, wherein the response comprises the resource ID stored by the RFID tag;
determine an estimated location of a mobile asset associated with the apparatus; and
transmit the (a) unique resource identifier for the at least one of the one or more resources from which the response was received and (b) estimated location of the mobile asset associated with the apparatus.

8. The apparatus claim 7, wherein the memory and computer program code are further configured to, with the processor, cause the apparatus to update an inventory record to reflect the estimated location of the mobile asset as the estimated location of the resource.

9. The apparatus claim 7, wherein the request from the mobile asset is transmitted after a determination that the mobile asset entered a geofenced area.

10. The apparatus claim 7, wherein the request from the mobile asset is transmitted after a determination that the mobile asset exited a geofenced area.

11. The apparatus claim 7, wherein the request from the mobile asset is transmitted on a periodic basis.

12. The apparatus claim 7, wherein the request from the mobile asset is transmitted via Bluetooth.

13. A computer program product for monitoring at least one resource, the computer program product comprising at least one non-transitory computer-readable storage medium having computer-readable program code portions stored therein, the computer-readable program code portions comprising:
an executable portion configured to transmit a request to be received by one or more radio identification (RFID) tags within a read range, wherein each of the one or more radio identification tags (a) is physically associated with a resource and (b) stores a unique resource identifier corresponding to the associated resource;
an executable portion configured to after transmitting the request within the read range to be received by the one or more RFID tags within the read range, receive a response from at least one of the one or more RFID tag within the read range, wherein the response comprises the resource ID stored by the RFID tag;
an executable portion configured to determine an estimated location of a mobile asset associated with the apparatus; and
an executable portion configured to transmit the (a) unique resource identifier for the at least one of the one or more resources from which the response was received and (b) estimated location of the mobile asset associated with the apparatus.

14. The computer program product claim 13 further comprising an executable portion configured to update an inventory record to reflect the estimated location of the mobile asset as the estimated location of the resource.

15. The computer program product claim 13, wherein the request from the mobile asset is transmitted after a determination that the mobile asset entered a geofenced area.

16. The computer program product claim 13, wherein the request from the mobile asset is transmitted after a determination that the mobile asset exited a geofenced area.

17. The computer program product claim 13, wherein the request from the mobile asset is transmitted on a periodic basis.

18. The apparatus claim 7, wherein the request from the mobile asset is transmitted via Bluetooth.
